(19) United States
(12) Patent Application Publication
(10) Pub. No.: US 2022/0161402 A1
(43) Pub. Date: May 26, 2022

(54) Screw Remover

(71) Applicant: Chao-Ming Chen, Taichung City (TW)

(72) Inventor: Chao-Ming Chen, Taichung City (TW)

(21) Appl. No.: 17/101,109

(22) Filed: Nov. 23, 2020

(51) Int. Cl. B25B 27/18

(52) U.S. Cl. CPC B25B 27/18

(57) ABSTRACT

The screw remover includes a head portion and a tail portion. The tail portion is coaxial to the head portion and is a frustum. A terminal face is formed at an end of the tail portion remote from the head portion. A diameter of the tail portion is reducing from toward the terminal face. At least one thread is formed on a peripheral face of the tail portion and spirally extends around an axis of the tail portion. At least one groove is formed on the peripheral face of the tail portion and traverses the at least one thread. An end of the at least one groove extends to the terminal face. Thereby, the screw can be rotated to remove by a driving tool when the tail portion is inserted into the screw and the head portion is connected to the driving tool.

### FIELD OF THE INVENTION

The present disclosure relates to a screw remover, more especially to a screw remover for removing a screw whose driving hole is damaged.

### BACKGROUND OF THE INVENTION

A screw or a bolt is common element in machines. The screw may be engaged with the threaded hole tightly due to the rust, the dust, or the deformation of the screw and the threaded hole so that removing the screw becomes difficult. If the user tries to detach the screw several times hard, the internal surface of the hexagonal hole of the screw may be abraded to be almost circular. As a result, the screw becomes more difficult to remove because the hexagonal hole cannot be engaged with common tools anymore.

To detach the damaged screw mentioned above, it is usual to drill a threaded hole on the screw or to form threads inside the original hexagonal hole so that the threads can be screwed by driving tools. However, drilling the threaded hole or forming threads inside the original hole is difficult and time-consuming. In addition, metal shavings may be generated, and the screw is irreversibly damaged. Furthermore, not every screw is big enough to form the new threaded hole or to form threads in the original hole.

The present invention is, therefore, arisen to obviate or at least mitigate the above mentioned disadvantages.

### SUMMARY OF THE INVENTION

One of the objects of the present invention is to provide a screw remover, which is adapted for detaching damaged screws easily without irreversible damage on the screws.

To achieve the above and other objects, the present invention provides a screw remover including a head portion and a tail portion. The head portion is adapted for connecting to a driving tool. The tail portion is coaxial to the head portion and is a frustum. A terminal face is formed at an end of the tail portion remote from the head portion. A diameter of the tail portion is reducing from an end thereof closer to the head portion toward the terminal face. At least one thread is formed on a peripheral face of the tail portion and spirally extends around an axis of the tail portion. At least one groove is formed on the peripheral face of the tail portion and traverses the at least one thread. An end of the at least one groove extends to the terminal face.

In some embodiments, a sleeve hole is formed on the head portion. The sleeve hole is a non-circular hole, and the tail portion is coaxial to the sleeve hole.

In some embodiments, a stepped portion is included. The stepped portion is a cylinder and is coaxial to the sleeve hole. The stepped portion connects the head portion and the tail portion therebetween. A diameter of the stepped portion is smaller than a diameter of the head portion.

In some embodiments, the terminal face of the tail portion defines a margin contour which is circular. The at least one groove forms an opening at the terminal face of the tail portion. Two ends of a contour of the opening are defined as a first end and a second end. A portion of the margin contour of the terminal face traversing the opening is defined as an imaginary contour. The imaginary contour extends from the first end to the second end. A bottom portion is defined as a portion of the contour of the opening which is most distant from the imaginary contour. A linear distance between the bottom portion and the first end is unequal to a linear distance between the bottom portion and the second end. Preferably, the contour of the opening of the at least one groove between the first end and the bottom portion is linear, and the contour of the opening of the at least one groove between the second end and the bottom portion is also linear so that the at least one groove is enclosed by two lateral walls. In another embodiment, the contour of the opening of the at least one groove is arc-shaped so that the at least one groove is enclosed by an arc-face.

In some embodiments, the head portion is a polygonal column.

In some embodiments, a depth of the at least one groove is increasing from an end thereof closer to the head portion toward an end thereof closer to the terminal face of the tail portion.

In some embodiments, an extending direction of the at least one groove is nonparallel to a generatrix of the tail portion.

In some embodiments, the tail portion is a conical frustum and has a taper which is ranged from 0.175 to 0.280. Preferably, a length of the at least one groove is larger than half a slant height of the tail portion.

In some embodiments, the terminal face is a concave arc face having a recessed central portion than a margin thereof.

In some embodiments, a number of the at least one thread is an integral multiple of 6.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

The present disclosure can be more fully understood by reading the following detailed description of the embodiment, with reference made to the accompanying drawings as follows:

FIG. 1 is a stereogram of the present invention;

FIG. 2 is a front view of the present invention;

FIG. 3 is a profile of the present invention;

FIG. 4 is a top view of the present invention;

FIG. 5 is a top view showing a second embodiment of the present invention;

FIG. 6 is an illustration of the present invention;

FIG. 7 is a stereogram showing a third embodiment of the present invention;

FIG. 8 is a top view showing a third embodiment of the present invention;

FIG. 9 is a stereogram showing a third embodiment of the present invention.

### DETAILED DESCRIPTION OF THE PREFERRED EMBODIMENTS

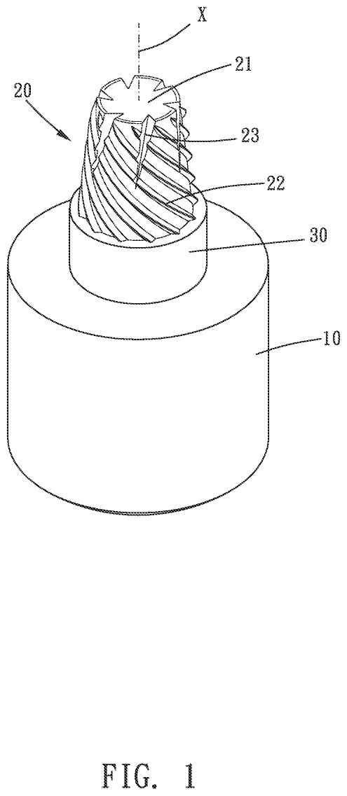

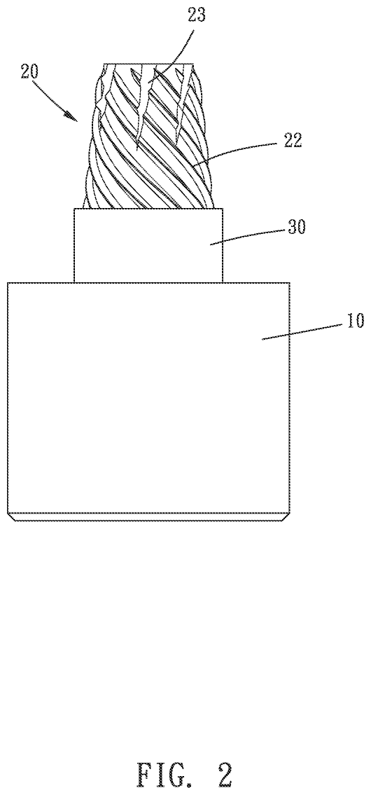

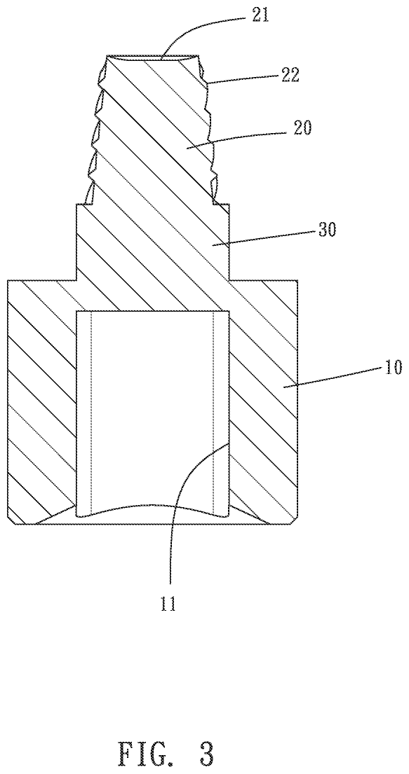

Please refer to FIG. 1 to FIG. 3, the screw remover of the present invention includes a head portion 10 and a tail portion 20. In the present embodiment, the head portion 10 has a sleeve hole 11 which is a non-circular hole such as a rectangular hole.

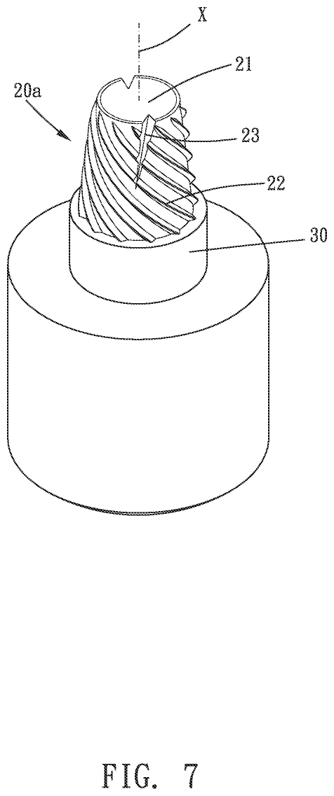

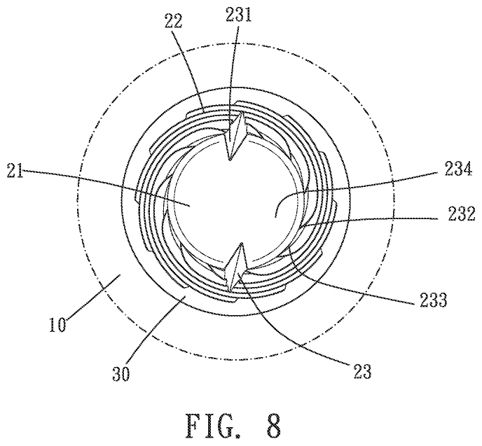

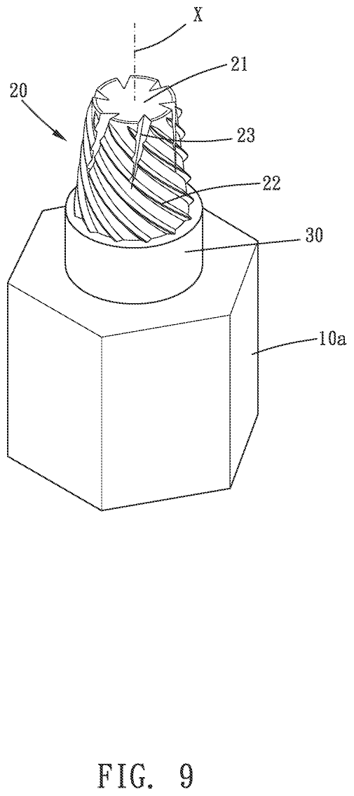

In addition, a guiding face is formed around the sleeve hole 11 so that the tool is easy to enter the sleeve hole 11. In other possible embodiments, the head portion 10a can be a polygonal column for connecting to a wrench, as shown in FIG. 9. The tail portion 20 is coaxial to the sleeve hole 11. The tail portion 20 is a frustum, more preferably a conical frustum whose taper is ranged from 0.175 to 0.280. That is, an angle between the generatrix of the tail portion 20 and the axis of the tail portion 20 is ranged from 5 degrees to 8 degrees. The tail portion 20 has a terminal face 21 at an end thereof remote from the head portion 10. The terminal face 21 is preferably an arc-face which is recessed at a center thereof. A diameter of the tail portion 20 is reducing from an end thereof closer to the head portion 10 toward the terminal face 21. At least one thread 22 is formed on a peripheral face of the tail portion 20 and spirally extends around an axis X of the tail portion 20. At least one groove 23 is formed on the peripheral face of the tail portion 20 and traverses the at least one thread 22. An end of the at least one groove 23 extends to the terminal face 21. Preferably, the screw remover is integrally formed by steel material, other metals, plastics, or other composite materials. In the present embodiment, the at least one thread 22 includes a plurality of said threads 22, whose number is preferably integer multiples of 6. The at least one groove 23 includes a plurality of said grooves 23, whose number is also preferably integer multiples of 6. The grooves 23 are arranged around the axis X of the tail portion 20 in equal intervals. Each of the grooves 23 traverses a plurality of the threads 22. In other possible embodiments, the number of the grooves of the tail portion 20a can be smaller than 6. For example, two said grooves 23 are included, as shown in FIG. 7 and FIG. 8.

In the present embodiment, the screw remover further includes a stepped portion 30. The stepped portion 30 is a cylinder and is coaxial to the sleeve hole 11. The stepped portion 30 connects the head portion 10 and the tail portion 20 therebetween. The diameter of the stepped portion 30 is smaller than the diameter of the head portion 10. Preferably, each of the head portion 10 and the stepped portion 30 is a cylinder.

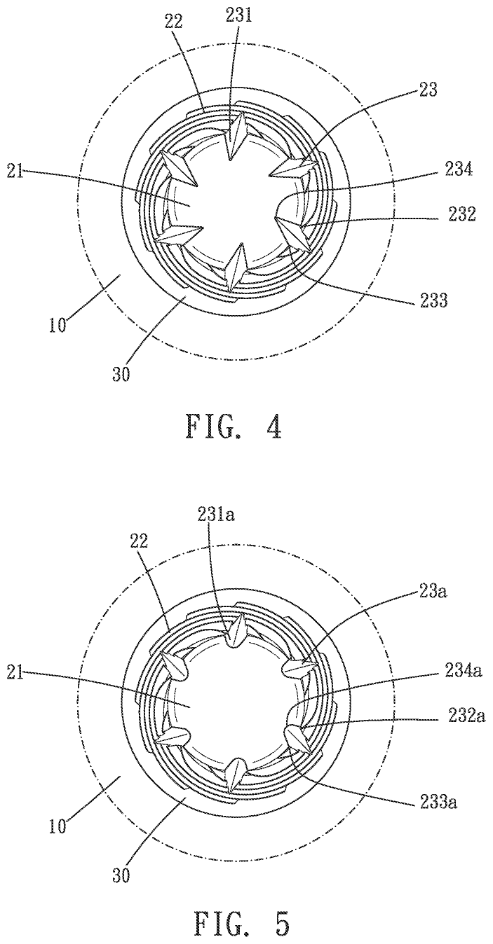

Please refer to FIG. 4 and FIG. 5, the terminal face 21 of the tail portion 20 defines a margin contour which is circular. The at least one groove 23,23a forms an opening 231,231a at the terminal face 21 of the tail portion 20. Two ends of a contour of the opening 231,231a are defined as a first end 232,232a and a second end 233,233a. A portion of the margin contour of the terminal face 21 traversing the opening 231,231a is defined as an imaginary contour (the outer arc contour). The imaginary contour extends from the first end 232,232a to the second end 233,233a. A bottom portion 234,234a is defined as a portion of the contour of the opening 231,231a which is most distant from the imaginary contour. A linear distance between the bottom portion 234,234a and the first end 232,232a is unequal to a linear distance between the bottom portion 234,234a and the second end 233,233a. Thus, the opening 231,231a is asymmetric along the circumferential direction. Preferably, the openings of the grooves 23,23a are inclined toward a same direction along the circumferential direction to correspond to the rotation direction of the screw.

In the present embodiment, the contour of the opening 231 of each of the grooves 23 between the first end 232 and the bottom portion 234 is linear, and the contour of the opening 231 of each of the grooves between the second end 233 and the bottom portion 234 is also linear so that each of the grooves 23 is enclosed by two lateral walls, as shown in FIG. 4. In other possible embodiments, the contour of the opening 231a of each of the grooves 23a is arc-shaped so that each of the grooves 23a is enclosed by an arc-face.

Specifically, to facilitate the tail portion 20 to engage with the hexagonal hole 51 of the screw 50, the longitudinal direction of each of the grooves 23,23a is nonparallel to the generatrix of the tail portion 20 so that the grooves 23,23a are inclined toward the same direction with respect to the generatrix of the tail portion 20. Preferably, the direction along which the grooves are inclined is opposite to the spiral direction of the thread 22. It is noted that the generatrix is defined as the hypotenuse of the right triangle to surround the axis to form a cone. Besides, to ensure the tail portion 20 is firmly engaged with the hexagonal hole 51, the depth of each of the grooves 23,23a is increasing from an end thereof closer to the head portion 10 toward an end thereof closer to the terminal face 21. That is, each of the grooves 23,23a has a maximum depth at the opening 231,231a. On the other hand, the length of each of the grooves 23,23a is preferably larger than half the slant height of the tail portion 20.

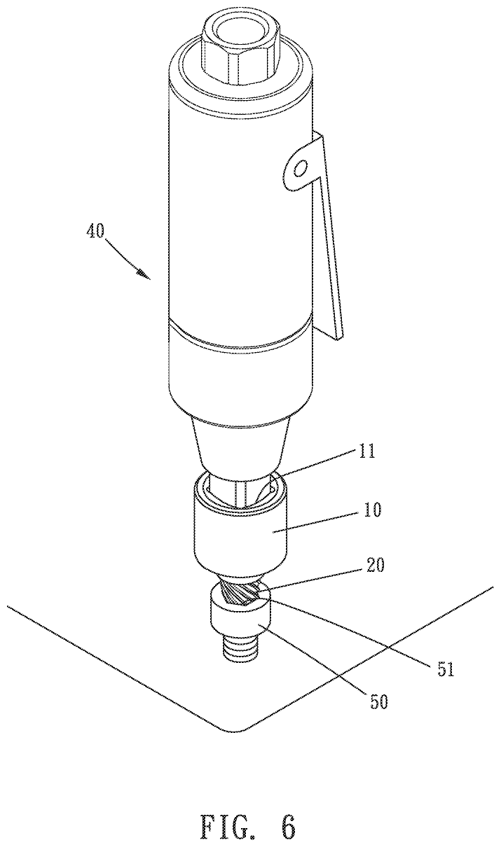

Please refer to FIG. 6 for the practical use. To remove the screw 50 having the hexagonal hole 51, connect a pneumatic wrench 40 or other rotation tool to the sleeve hole 11, and insert the tail portion 20 into the hexagonal hole 51 of the screw 50. When the screw remover is rotated by the pneumatic wrench 40, the tail portion 20 is embedded into the hexagonal hole 51 of the screw 50 firmly because the tail portion is cone-shaped. Thus, Thereby, the screw 50 can be rotated too to be removed when the screw remover is rotated by the pneumatic wrench 40.

Because the tail portion is cone-shaped, the tail portion can be firmly engaged with the screw by inserting the tail portion into the hexagonal hole in different depths no matter the hexagonal hole is damaged seriously or not. Besides, the present invention can be used to remove the screw whose hexagonal hole is still intact when lacking of the screw driver in the right size.

In conclusion, the screw remover of the present invention can be used to detach the screw having polygonal hole without drilling holes on the screw. It is time-saving and no metal shaving is generated. Also, the cone-shaped tail portion is suitable for polygonal holes in different sizes, and the intact screw is able to be detached by the present invention too. Besides, the grooves provide a bumpy surface on the tail portion along the circumferential direction so that the tail portion can be firmly engaged with the polygonal hole to make it easier to detach the screw.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A screw remover including a head portion and a tail portion, the head portion being adapted for connecting to a driving tool, the tail portion being coaxial to the head portion, the tail portion being a frustum, a terminal face being formed at an end of the tail portion remote from the head portion, a diameter of the tail portion being reducing from an end thereof closer to the head portion toward the terminal face, at least one thread being formed on a peripheral face of the tail portion and spirally extending around an axis of the tail portion, at least one groove being formed on the peripheral face of the tail portion and traversing the at least one thread, an end of the at least one groove extending to the terminal face.

2. The screw remover of claim 1, wherein a sleeve hole is formed on the head portion, the sleeve hole is a non-circular hole, the tail portion is coaxial to the sleeve hole.

3. The screw remover of claim 1, wherein the head portion is a polygonal column.

4. The screw remover of claim 2, further including a stepped portion, the stepped portion being a cylinder and being coaxial to the sleeve hole, the stepped portion connecting the head portion and the tail portion therebetween, a diameter of the stepped portion being smaller than a diameter of the head portion.

5. The screw remover of claim 1, wherein the terminal face of the tail portion defines a margin contour which is circular, the at least one groove forms an opening at the terminal face of the tail portion, two ends of a contour of the opening are defined as a first end and a second end, a portion of the margin contour of the terminal face traversing the opening is defined as an imaginary contour, the imaginary contour extends from the first end to the second end, a bottom portion is defined as a portion of the contour of the opening which is most distant from the imaginary contour, a linear distance between the bottom portion and the first end is unequal to a linear distance between the bottom portion and the second end.

6. The screw remover of claim 5, wherein the contour of the opening of the at least one groove between the first end and the bottom portion is linear, the contour of the opening of the at least one groove between the second end and the bottom portion is also linear so that the at least one groove is enclosed by two lateral walls.

7. The screw remover of claim 5, wherein the contour of the opening of the at least one groove is arc-shaped so that the at least one groove is enclosed by an arc-face.

8. The screw remover of claim 1, wherein a depth of the at least one groove is increasing from an end thereof closer to the head portion toward an end thereof closer to the terminal face of the tail portion.

9. The screw remover of claim 1, wherein an extending direction of the at least one groove is nonparallel to a generatrix of the tail portion.

10. The screw remover of claim 1, wherein the tail portion is a conical frustum and has a taper which is ranged from 0.175 to 0.280.

11. The screw remover of claim 10, wherein a length of the at least one groove is larger than half a slant height of the tail portion.

12. The screw remover of claim 1, wherein a number of the at least one groove is an integral multiple of 6, the grooves are arranged around the axis of the tail portion in equal intervals.

13. The screw remover of claim 1, wherein the terminal face is a concave arc face having a recessed central portion than a margin thereof

14. The screw remover of claim 1, wherein a number of the at least one thread is an integral multiple of 6.
